(19) United States
(12) Patent Application Publication
(10) Pub. No.: US 2019/0123832 A1
(43) Pub. Date: Apr. 25, 2019

(54) PHASE RECOVERY FOR SIGNALS WITH QUADRATURE AMPLITUDE MODULATION

(71) Applicant: Roshmere, Inc., San Diego, CA (US)

(72) Inventors: Nikola Alic, La Jolla, CA (US); Eduardo Temprana Giraldo, La Jolla, CA (US)

(73) Assignee: Roshmere, Inc., San Diego, CA (US)

(21) Appl. No.: 16/162,076

(22) Filed: Oct. 16, 2018

Related U.S. Application Data
(60) Provisional application No. 62/575,343, filed on Oct. 20, 2017.

(51) Int. Cl. H04B 10/61; H04L 27/38

(52) U.S. Cl. CPC H04B 10/6165; H04L 27/3818; H04B 10/6164

(57) ABSTRACT

Phase noise is corrected in a communication system including a modulated signal having a constellation including multiple constellation points. The system and methods include a coarse phase recovery followed by a fine phase recovery. Coarse phase corrected points can be generated using an M^{th} power operation. Fine phase corrected points can be generated by rotating each coarse phase corrected point by an angle that is determined by the location of that coarse phase corrected point in the constellation, and applying a phase offset function to each transformed point. A phase noise mitigated constellation can be generated by derotating the fine phase corrected points.

### RELATED APPLICATIONS

This application claims the benefit of U.S. Provisional Patent Application No. 62/575,343 filed on Oct. 20, 2017, and entitled “PHASE RECOVERY FOR SIGNALS WITH QUADRATURE AMPLITUDE MODULATION”; which is hereby incorporated by reference for all purposes.

### BACKGROUND

Communication systems typically rely on Quadrature Amplitude Modulation (QAM) techniques that use the In-Phase and Quadrature tributaries of the carrier to transmit information. Among the QAM modulation formats, the simplest is the so called Quaternary Phase Shift Keying (QPSK), which consists of four (hence the name—quaternary) possible phase points equally spaced on a circle, and are thus separated by 90 degrees. Specifically, in optical communications the QPSK was used predominantly in the form of dual polarization QPSK systems, in which independent information is transmitted in two orthogonal polarizations of the electric field. The oscillators used for transmission and reception of QAM signals have finite frequency and phase stability (or conversely—uncertainty), which manifest as oscillator phase noise. Particularly, oscillators in optical communications are embodied in the form of lasers and have finite linewidths, a measure that is inversely proportional to the laser phase stability (i.e., the broader the linewidth, the less stable the phase, or the greater the phase uncertainty, of the carrier will be). Oscillator, or laser phase, noise affects the performance of communication systems by distorting the received waveforms and introducing errors in the transmitted data. As a solution, communication systems typically rely on phase recovery techniques that are used to estimate the phase evolution of the carrier, and compensate the received signal to minimize the errors in transmission caused by the carrier phase uncertainty (or the phase noise). Phase noise in QPSK signals can be tracked and corrected using a well-established blind phase recovery technique called the fourth power algorithm. In such methods, the received quaternary symbols are raised to the fourth power operation, which rotates the constellation points to the real axis and eliminates the phase modulation from the data, leaving only the phase offsets that originate from the carrier phase noise. After eliminating the data-dependent phase modulation, the phase evolution of the carrier is estimated by taking a moving average of the remaining phase information, and the estimated phase offsets are applied to the received constellation points to reduce the phase uncertainty in the signal.

The transmission capacity of communication systems (and especially optical communications) can be improved using higher order modulation, such as 16-QAM, or higher. Phase recovery in higher order QAM signals (i.e., 16-QAM or higher) is challenging, in part because the points in the constellations will not be rotated to the real axis using a simple fourth power operation, and thus the phase modulation due to the transmitted data will not be eliminated. Multiple methods have been developed to address this challenge, however each of the existing methods carries limitations that underperform in the compensation of phase noise in higher order QAM signals. In one existing method, the fraction of the symbols that can be rotated to the real axis using a fourth power operation can be used to determine an average phase offset for all the points in the signal, and this single value of the phase offset can be applied to all points in the constellation for phase recovery. A limitation of this method is that it may not be able to appropriately capture the phase offset evolution within a frame of information symbols. In other existing methods, the higher order constellations are partitioned into sub-groups, each sub-group containing different arrangements of QPSK-equivalent constellations, and each sub-group being rotated by a predetermined angle so that the phase offset can be determined for each sub-group (of partitioned QPSK symbols) utilizing conventional phase recovery algorithms developed for QPSK signals. A limitation of that method is that the predetermined angles used for rotation may or may not correspond to the optimal angular rotation for optimal phase retrieval.

### SUMMARY

In some embodiments, a method is disclosed for correcting phase noise in a communication system comprising the following operations. A signal having a constellation including multiple constellation points is received by a phase correction system. Coarse phase corrected points can be generated in an operation comprising a first M^{th} power phase recovery on each of the multiple constellation points. Partitioned coarse phase corrected points can then be generated by partitioning the coarse phase corrected points into several partitioned groups. Rotated points can then be generated by rotating each partitioned coarse phase corrected point by an angle that corresponds to the location of that coarse phase corrected point in the constellation. M^{th} power transformed points can be generated by performing a second M^{th} power operation on each of the rotated points. A fine phase correction function of each M^{th} power transformed point can be generated by performing a moving average of a phase offset of each M^{th} power transformed point, the fine phase correction function describing the phase offset of each point as a function of time. Fine phase correction for the constellation points can then be generated by performing a fine phase recovery using the fine phase correction function to apply a phase correction (i.e., calculated in the preceding step) using the M^{th} power algorithm on each transformed point. A phase noise mitigated constellation can then be generated by derotating the fine phase corrected points, wherein the derotating removes rotations added by the rotating step and the fourth power operations.

In some embodiments of the method described above, the constellation is a higher order constellation, with order 16 or greater.

In some embodiments of the method described above, the first and second M^{th} power operations are fourth power operations.

In some embodiments, the received modulated signal is a quadrature amplitude modulated (QAM) signal, and the constellation is a QAM constellation.

In some embodiments of the method described above, the coarse phase corrected points (i.e., the points of the constellation after the coarse phase correction operations described herein are performed) are partitioned into four or more partitioned groups. In some embodiments of the method described above, each of the partitioned coarse phase corrected points is rotated by an angle that is determined by the partitioned group of each point. In some embodiments of the method described above, the coarse phase corrected points are partitioned into rectangular partitioned groups.

In some embodiments of the method described above, the partitioned groups each comprise 1 or 2 of the coarse phase corrected points.

In some embodiments of the method described above, each of the partitioned coarse phase corrected points is rotated by an angle that is determined by the location of the point, and by a number of other coarse phase corrected points. In some embodiments of the method described above, each of the partitioned coarse phase corrected points is rotated by an angle that is determined by the average position of a set of 2 partitioned coarse phase corrected.

### BRIEF DESCRIPTION OF THE DRAWINGS

FIG. 1A is an illustration of an ideal 16-QAM constellation with no phase noise, and rectangular partition boundaries.

FIG. 1B is an example of a 16-QAM constellation with a static phase offset, phase noise, and rectangular partition boundaries.

FIG. 2 is a simplified schematic of an example system, and the corresponding receiver DSP stages, in accordance with some embodiments.

FIGS. 3A and 3B are examples of a 16-QAM constellation after coarse phase recovery, including three example points, in accordance with some embodiments.

FIG. 4 shows an example of the three example points rotated to the real axis, in accordance with some embodiments.

FIG. 5 shows an example of the three example points after the fine phase recovery stage is applied, in accordance with some embodiments.

FIG. 6 shows an example of the three example points after derotation to their original locations, in accordance with some embodiments.

FIG. 7 shows an example of the full 16-QAM constellation after phase recovery operations, in accordance with some embodiments.

FIG. 8A shows an example of a 16-QAM constellation with a partitioned group containing non-adjacent points, in accordance with some embodiments.

FIG. 8B shows an example of a 16-QAM constellation with a partitioned group containing non-adjacent points, in accordance with some embodiments.

FIG. 8C shows an example of a 64 QAM constellation with a partitioned group containing non-adjacent points, in accordance with some embodiments.

FIG. 9 shows a flowchart for a method for phase recovery in a higher order QAM system, in accordance with some embodiments.

### DETAILED DESCRIPTION

The transmission capacity of communication systems, including optical, satellite, wireline and wireless communication systems, using Quadrature Amplitude Modulation (QAM) can be increased using higher order modulation (e.g., 16-QAM, or higher), instead of the conventional Quadrature Phase Shift Keying (QPSK). A phase recovery operation generally attempts to correct for the innate, randomly evolving phase of the oscillators used in the system, often referred to as phase noise in a QAM signal. The current disclosure discusses systems and methods for phase recovery for, or correcting phase noise in, higher order QAM systems, which overcome at least some of the limitations of existing systems and methods. In some embodiments, every point in the higher order QAM constellation is rotated to the real axis as part of the phase recovery methods. In some embodiments, a unique rotation angle is determined for each partition group corresponding to a particular point in the constellation. As a consequence, there can be a plurality of different rotation angles (e.g., 2, or 3, or 4, or 8, or 16, or more than 16 different rotation angles) used to rotate all of the points in the constellation to the real axis. Once rotated to the real axis, the phase evolution of the carrier can be tracked and corrected for each constellation point individually, which yields improved phase estimation compared with conventional systems and methods. The system and method can be used to estimate the carrier phase evolution and be implemented as part of the receiver DSP of the QAM system.

Rotating all points in the constellation by a unique angle is beneficial because it can reduce errors that can be caused by phase recovery methods using static phase offsets. Additionally, phase recovery is typically performed over a certain finite time window to track the evolution of the phase of the carrier. Methods that rely on rotating groups of symbols (e.g., groups having the arrangement corresponding to QPSK signals) may not sample all of the required points within a certain partition group, given that those symbols may occur infrequently over the given time window, and this can lead to additional errors.

In some embodiments, a method is disclosed for correcting phase noise in QAM systems comprising the following operations. A QAM signal having a QAM constellation including multiple points is processed using a multistage phase correction system. Coarse phase corrected points can be generated in an operation comprising a first M^{th} power operation on all of the plurality of points in the QAM constellation within a given time interval (or frame of symbols). In some embodiments, the coarse phase corrected points can be generated using an M^{th} power operation, a variation of the M^{th} power operation, a Cartwright algorithm, a variation on a Cartwright algorithm, or other similar methods for coarse phase recovery. In some embodiments a pilot signal, or a tone can be used for coarse phase correction. As an example, a pilot symbol can consist of a known symbol (i.e., a particular constellation point) at a particular position in the transmitted sequence, or a frame. Thus, owing to the property of the known phase, the pilot symbols can be used to aid with phase recovery, or in particular with coarse phase recovery associated with the current invention. The coarse phase corrected points are partitioned into groups that belong to the ideal symbols in the constellation. Each partitioned group of coarsely phase-corrected points is then rotated by an angle determined by the location of the symbol corresponding to that group. The phase evolution of the carrier can then be estimated finely by means of a second M^{th} power operation, whereas a moving average is used to compensate the phase noise on the angularly misplaced (i.e., rotated) symbols. The original QAM constellation devoid of phase uncertainty can then be reconstructed by derotating the fine phase corrected points back to their original locations, wherein the derotation removes the angular shifts (i.e., rotations) added by the rotation step. In some embodiments, the QAM constellation (or QAM system) is a higher order QAM system, with order 16 or greater. In some embodiments, the first and second M^{th} power operations are fourth power operations. In some embodiments, the coarse phase corrected points (i.e., the points of the QAM constellation after the coarse phase correction operations described herein are performed) are partitioned into groups that do not correspond to QPSK-like arrangements. In some embodiments, the coarse phase corrected points are partitioned into groups delimited by rectangular boundaries. In some embodiments, the partitioned groups each comprise 1, or 2, or 4, or 8, or more than 8, of the coarse phase corrected points. In some embodiments, each of the partitioned groups of coarse phase corrected points is rotated by the average angle of all points belonging to the group. In some embodiments, each of the partitioned coarse phase corrected points is rotated by an angle that is determined by the average location of that point, and a number of other coarse phase corrected points. In some embodiments, each point of the partitioned coarse phase corrected constellation is rotated by an angle that is determined by the average position of two sets of points.

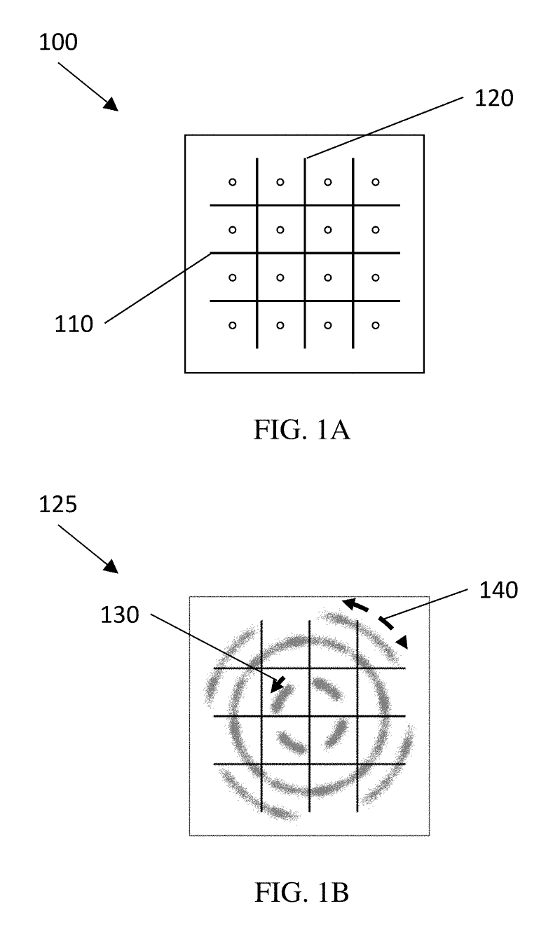

FIG. 1A illustrates an ideal QAM constellation 100 of a QAM signal, i.e., with no phase noise. The horizontal axis 110 in FIG. 1A is the real axis (i.e., In Phase axis) and the vertical axis 120 is the imaginary axis (i.e., the Quadrature axis). Each point (i.e., “symbol”) in the ideal QAM constellation is a discrete point with no overlap with other points in the constellation. Ideally, a transmitted QAM signal is formed as close to such an ideal constellation as is possible, but in reality, amplitude noise and phase noise distort the location of the symbols, shifting, or rotating, the points away from their ideal location. FIG. 1B, on the other hand, illustrates an example of a real-world QAM constellation 125, i.e., with phase noise that has been impaired by additive white Gaussian noise (AWGN). (The QAM constellations 100 and 125 are shown for 16-QAM signals, but the phase noise in any other higher order QAM signal can also be mitigated using the present systems and methods.) Phase noise causes a global rotation of the constellation (e.g., as shown by arrow 130), as well as angular uncertainty, as denoted by the rotational smearing of each symbol (e.g., as shown by arrow 140). In the example shown in FIG. 1B, the phase noise is large enough that extended arcs and even rings, rather than discrete non-overlapping points, are created in the constellation.

In some embodiments, the technique described herein is applicable to non-QAM constellations, such as rings, stars, rectangles, probabilistically shaped, non-probabilistically shaped and circular constellations, or irregularly shaped, or construed constellations. In other words, a grid for the constellation need not be square. In some embodiments, trellis coding can be used to separate the signal into two or more constellation sub-sets, and the present phase recovery systems and methods are used to reduce the phase noise in each of the separated constellations. For example, alternating (or adjacent) symbols can be separated into two constellations (e.g., to increase the spacing between points in each of the resulting constellations), and then the present phase recovery systems and methods can be used to reduce the phase noise in each of the constellations. In some embodiments, constrained and/or error-correction coding can be used, and then the present phase recovery systems and methods are used to reduce the phase noise in the constrained and/or error-corrected constellations. For example, in some methods of constrained and/or error-correction coding some combinations of consecutive symbols are forbidden, which can be problematic for conventional phase correction methods (e.g., those using global rotation angles). The present phase correction systems and methods, however, are more capable of reducing the phase noise in constrained and/or error-corrected constellations because the present systems and methods are capable of correcting the phase noise of each symbol in the constellation independently. In some embodiments, the present phase correction methods are used to reduce phase noise in constellation sets that change and/or alternate among several different constellation sets over adjacent time instants. In some embodiments, the present phase correction methods are used to reduce phase noise in system using trellis coded modulation, or extensions to trellis coded modulation, such as modulation with dynamic constellation switching.

The points or symbols in the example QAM constellation in FIG. 1B include multiple occurrences of the same point, or symbol. As used herein, therefore, the terms “point” and “symbol” refer to one, or more than one, occurrence of an individual point, or symbol in the QAM constellation. Thus, as used herein, a reference to any given point or symbol in a QAM signal can refer to multiple occurrences of that point in the constellation. Consequently, in some embodiments, an average of an attribute of a point refers to an average of that attribute for multiple occurrences of that point.

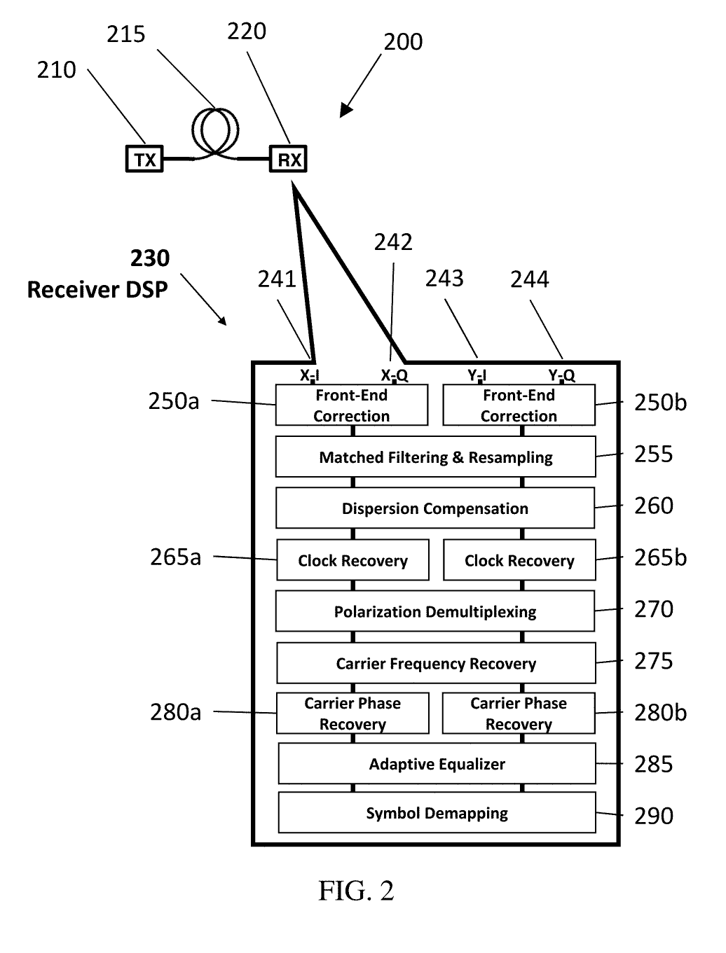

FIG. 2 shows a simplified schematic of an optical communication system 200 using Quadrature Amplitude Modulation (QAM), in accordance with one or more example embodiments. Some elements are omitted for ease of illustration and explanation. The system 200 generally includes a transmitter 210, a transmission link 215, and a receiver 220. The transmitter 210 transmits a QAM signal through the transmission link 215, including fiber optic cables and optical amplifiers in some embodiments. The transmitted QAM signal is received by the receiver 220, which includes a digital signal processor that performs a digital signal processing (DSP) chain 230. Although FIG. 2 shows an example of an optical system, the present phase recovery systems and methods can also be applicable to other systems such as satellite, wireline and wireless communication systems. In some embodiments, the present phase recovery systems and methods are applicable to other systems and include similar components or similar functions as described herein modified as appropriate for the different embodiments.

The multiple processing blocks of the DSP chain 230 performed by the digital signal processor generally include, but are not limited to, for example, receiver front-end correction blocks 250a and 250b, a matched filtering and resampling block 255, a dispersion compensation block 260, clock recovery blocks 265a and 265b, a polarization demultiplexing block 270, a carrier frequency recovery block 275, carrier phase recovery blocks 280a and 280b, an adaptive equalizer block 285, and a symbol demapping block 290. In some embodiments, one or more processing blocks (e.g., the carrier phase recovery blocks 280a and 280b) in the DSP performs phase recovery. Processing performed by the DSP chain 230 includes equalization of impairments accumulated in transmission of a combined modulated carrier signal, followed by demodulation and information retrieval. In the example shown in FIG. 2, the signals 241 through 244 are in-phase (I) and quadrature (Q) components (X-I, X-Q, Y-I and Y-Q) of the X and Y polarizations of the electric field for a single WDM information channel after photo-detection and analog-to-digital (ADC) conversion. Digital representations of the signals 241 through 244 are transmitted to the in-phase and quadrature component (IQ) front-end correction blocks 250a and 250b, which perform in-phase and quadrature imbalance correction and scaling on the X and Y polarizations respectively. Matched filtering and resampling is then performed on the corrected signals at the block 255. At the dispersion compensation block 260, accumulated chromatic dispersion is estimated. Next, the clock recovery blocks 265a and 265b perform clock recovery on the signals from the X and Y polarizations, respectively. The polarization demultiplexing block 270 then performs polarization decoupling and equalization. The carrier frequency recovery block 275 estimates and recovers the frequency of the carrier signal. At the carrier phase recovery blocks 280a and 280b, the carrier signal phase compensation is performed on the X and Y polarizations, respectively. The signal is then processed through adaptive equalizer block 285. In some embodiments, the adaptive equalizer block 285, performs chromatic dispersion equalization and/or compensation. Constellation de-mapping is then performed by the symbol demapping block 290.

Phase recovery systems and methods, such as those in blocks 280a and 280b will now be discussed. In some embodiments, a phase recovery method first includes the phase recovery system performing a coarse phase recovery, which includes a fourth power operation, and applies a single estimated or calculated phase offset to all of the points in the constellation. To reduce the phase noise further, the method can further include the phase recovery system performing a fine phase recovery. In some embodiments, after the coarse phase recovery is performed, a fine phase recovery is performed by the phase recovery system including: subdividing the coarse phase corrected QAM constellation into partitioned groups; rotating each point in the partitioned coarse phase corrected constellation by an angle that is determined by the ideal location of each point; performing a fourth power operation on the rotated coarse phase corrected constellation; performing a moving average of the phase offset to improve the quality of phase recovery and determine a phase evolution (e.g., a fine phase correction function or phase offset function) that describes the phase offset as a function of time; and then using the fine phase correction function to apply a separate phase correction to each symbol independently. In some embodiments, the moving average is calculated for 10 symbols, or for 100 symbols, or for from 3 to 10, or for from 3 to 50, or for from 3 to 100, or for from 20 to 100 symbols. The number of symbols used in the moving average calculation can be different for different applications, and can be influenced by one or more system components, such as by the quality of the oscillator in the system. All rotations are then removed to produce a fine phase corrected QAM constellation with an effective degree of phase noise correction.

In some embodiments of the method described above, the QAM system is a higher order QAM system. For example, the QAM system can have an order of 16 or higher, or be a 16-QAM system, or a 32-QAM system, or a 64-QAM system, or a 128-QAM system, a 256-QAM system, or higher order QAM system.

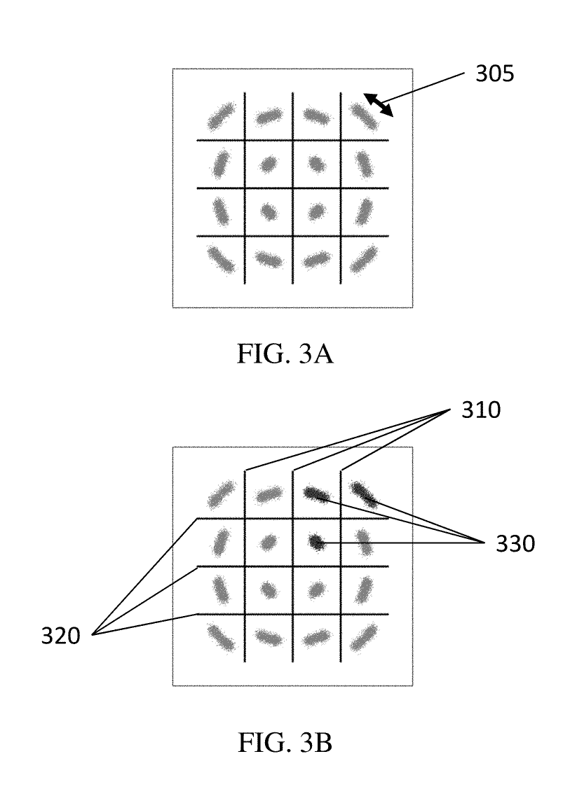

FIG. 3A illustrates the 16-QAM constellation with phase noise shown in FIG. 1B after a coarse phase recovery is performed. FIG. 3A illustrates that the global rotation from the phase noise (e.g., shown by arrow 130 in FIG. 1B) has been substantially reduced, however the rotational smearing has only been reduced to some extent. The points in the constellation still have some phase uncertainty, as recognized by rotational smearing as shown by arrow 305. In some embodiments, the coarse phase recovery includes performing a first M^{th} power operation, which can be a fourth power operation, or an eighth power operation, or a twelfth power operation, etc. The first M^{th} power operation rotates each point in the constellation, which rotate a portion (but not all) of the points in a higher order QAM constellation to the real axis. In some embodiments, after the first M^{th} power operation, the phase evolution is estimated by performing a moving average of the phase offset of a finite number of rotated symbols. The estimated phase offset is then applied to the rotated points in the constellation to reduce the phase noise.

After the coarse phase recovery is performed, a fine phase recovery can be performed to further reduce the phase uncertainty/phase noise in the signal. FIGS. 3B-7 show an example of a fine phase recovery on a higher order QAM system, in accordance with some embodiments.

In some embodiments, the first step in the fine phase recovery method is to subdivide the QAM constellation into partitioned groups. FIG. 3B shows an example of partitioned groups. In this example, the vertical lines 310 and the horizontal lines 320 partition the constellation into 16 groups, each of which contains one point (i.e., each partitioned group in this example contains one symbol). In some embodiments, the coarse phase corrected QAM constellation is subdivided into rectangular partitions. In some embodiments, the coarse phase corrected QAM constellation is partitioned into 4 or more groups, or 8 or more groups, or 16 or more groups, or 32 or more groups, or 64 or more groups, or 128 or more groups, or any appropriate or practical number of groups. In some embodiments, each of the coarse phase corrected subdivision groups contain received symbols corresponding to one constellation point corresponding to the ideal QAM constellation, or two constellation points corresponding to the ideal QAM constellation, or four constellation points corresponding to the ideal QAM constellation, or eight constellation points corresponding to the ideal QAM constellation.

In some embodiments, the points in the constellation can be partitioned into groups containing 2 or more points that are adjacent to each other in the constellation. For example, the constellation can be partitioned into rectangular partitions each containing 2 or more points, or 4 or more points, or 2 points, or 4 points, or 8 points, or 16 points that are adjacent to each other. In other embodiments, the points in the constellation can be partitioned into groups containing 2 or more points that are not adjacent to each other in the constellation. In some embodiments, the constellation can be partitioned into partitions, or groups, each containing 2 or more points, or 4 or more points, or 2 points, or 4 points, or 8 points, or 16 points that do not correspond to QPSK-like arrangements. Embodiments including groups with non-adjacent points will be discussed in a later section of this disclosure.

For purposes of illustration, three points will be used to describe the next operations in the fine phase recovery. However, it should be understood that all of the symbols in the constellation will undergo similar operations as will be shown for the three example points. FIG. 3B shows the three example points 330 that will be used to illustrate the next operations in the fine phase recovery.

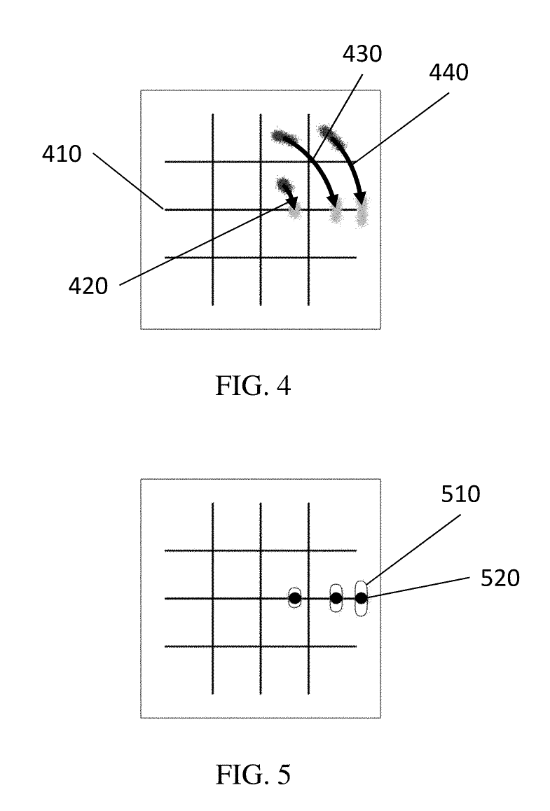

FIG. 4 shows an example of the three example points rotated to the real axis 410. In this example, each of the points is rotated by an angle needed to rotate the point to the real axis, which are the angles 420, 430 and 440 in this example. In some embodiments, every point will be rotated by a different angle. For example, angle 420 can be approximately 45°, while angle 430 can be approximately 60°. In the methods described herein, the rotation angles for the points in the constellation are not constrained to predetermined values. On the contrary, all points are rotated by whatever angles are required or appropriate for each individual point, which provides superior phase noise reduction compared to existing methods, especially for higher order QAM systems. In some embodiments, 2 or more of the points will be rotated by the same or similar angle. For example, angle 420 and angle 440 could be the same (or almost the same) angle in the example shown in FIG. 4. In other embodiments, the angles 420 and 440 are slightly different angles to bring the constellation points to the real axis with improved accuracy. For example, the magnitudes of angles 420 and 440 can both be 45°, or angles close to 45° but not exactly 45°. In the case of higher order QAM constellations, the rotation angles can be angles that are not necessarily multiples of approximately 15°. Furthermore, for QAM constellations of increasingly higher order, the phase angles between points in the constellation become smaller, and rotating all points to the real axis through simple predetermined angles becomes less practical.

Each point of the partitioned coarse phase corrected constellation can be rotated by an angle that is determined by the angle determined by its estimated association to a particular ideal constellation point. One example of this type of rotation includes rotating each point by an angle that corresponds to the center of the partition of the point, i.e., ideal constellation point location. In another example, each point can be rotated by an angle that corresponds to a corner or a predetermined point along an edge of the partition of the point.

In some embodiments, the average position of each point (i.e., symbol) in the constellation can be determined, and the average position used to determine the rotation angle for each point. For example, the average position can be determined by taking a moving average over time of the position of the point (i.e., a moving average of multiple occurrences of the point) within a partition. If there is more than one point in a partition, the points can be rotated by an angle that corresponds to the average angle of one of the points, or more than one point, or all of the points contained within the partition. In some embodiments, the averaging can be performed as a weighted average. For example, more weight can be assigned to points that are closer in time to the point under evaluation, such as by using a Gaussian, or trapezoidal weighting function. In other embodiments, the averaging can be done using equal weighting for each point (e.g., within a rectangular partition window).

In some embodiments, each point of the constellation is rotated by an angle that is determined by the location of the point, and by a number of other points in the constellation. For example, each point of the partitioned coarse phase corrected constellation can be rotated by an angle that is determined by the average position of a set of 2 points, or a set of 4 points, or a set of 8 points, or a set of 16 points. In some embodiments, each point of the partitioned coarse phase corrected constellation can be rotated by an angle that is determined by the average position of points in the ideal constellation.

FIG. 5 shows an example of the three example points after the points are rotated to the real axis and the phase offset is estimated and applied to each point. FIG. 5 shows the three example points after rotation as arcs (e.g., 510) with particular angular distributions around the real axis. A second M^{th} power operation is performed to reduce the phase noise of the rotated points. In some embodiments, this second M^{th} power operation is a fourth power operation, or an eighth power operation, or a twelfth power operation, etc. After this second M^{th} power operation, a moving average of the phase offset is estimated for each point (e.g., reducing the angular spread of the arcs 510 to points 520), and the moving average is used to adjust the phase of the points before derotating to recover the constellation. In some embodiments, the moving average of the phase offset is used to determine a phase evolution (e.g., a fine phase correction function or phase offset function) that describes the phase offset as a function of time. The fine phase correction function can then be used to adjust the phase of the points before derotating to recover the constellation. In some embodiments, the averaging can be performed as a weighted average. For example, more weight can be assigned to points that are closer in time to the point of interest, such as by using a Gaussian or trapezoidal weighting function. In other embodiments, the averaging can be done using equal weighting for each point (e.g., within a rectangular partition window).

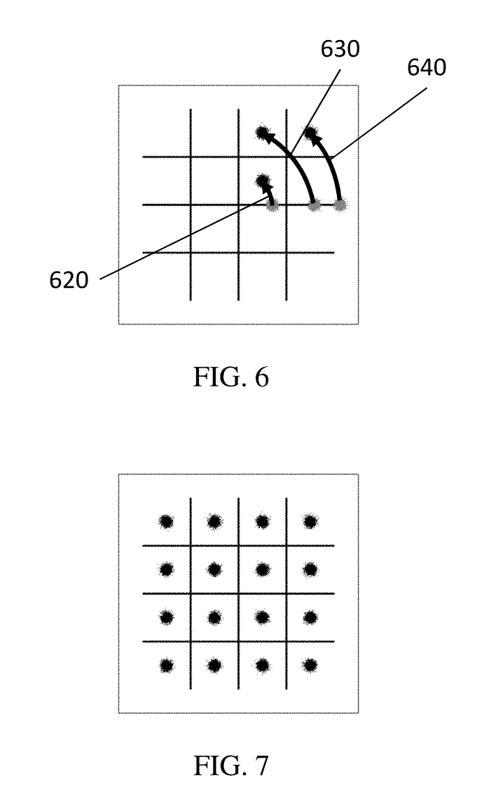

FIG. 6 shows an example of the three example points before and after derotating to recover the QAM constellation with the phase and amplitude information for each point. FIG. 6 shows the derotation angles 620, 630, and 640 of the three example points, and that the derotation angles 620, 630, and 640 are not necessarily all the same angle. In some embodiments, every point will be derotated by different angles. In some embodiments, 2 or more of the points will be derotated by the same angle. For example, angle 620 and angle 640 could be the same angle in the example shown in FIG. 6. In other embodiments, the angles 620 and 640 could be slightly different angles to bring the constellation points back to their locations within the constellation with improved accuracy.

FIG. 7 shows an example of the full phase noise mitigated 16-QAM constellation, after the coarse and fine phase recovery operations, including derotation of the points, are complete. In some embodiments, the phase noise of each point in the higher order QAM constellation will be reduced by a factor of greater than 10, or greater than 100, compared to the received constellation (e.g., shown in FIG. 1B). In some embodiments, the phase noise of each point in the higher order QAM constellation will be reduced such that the standard deviation of the phase of each point will be less than 10 degrees, or less than 5 degrees, compared to the received constellation (e.g., shown in FIG. 1B). In some embodiments, the bit error rate (BER), will be reduced by a factor of greater than 10, or greater than 100, compared to the received constellation (e.g., shown in FIG. 1B). Additionally, the phase recovery systems and methods described herein are more resilient to amplitude noise than conventional phase recovery systems and methods. In some embodiments, a signal suffers from 10 dB, or 20 dB, or 25 dB amplitude noise, or from 10 to 30 dB amplitude noise, and the phase noise and/or the BER of the signal is improved by the amount(s) described above.

In some embodiments, the points within a partition are not adjacent to each other in the constellation. In other words, a single partitioned group can contain two or more points that are not adjacent to one another in the constellation. In such cases, the angle(s) of rotation for each point can be determined from the average position, or the average angle, of one or more of the non-adjacent points in the partition, subject to one or more further mathematical transformations.

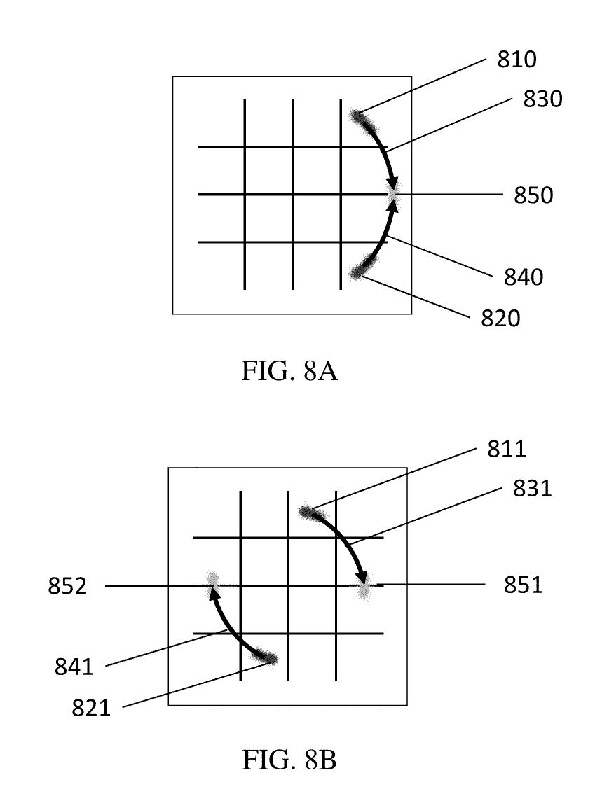

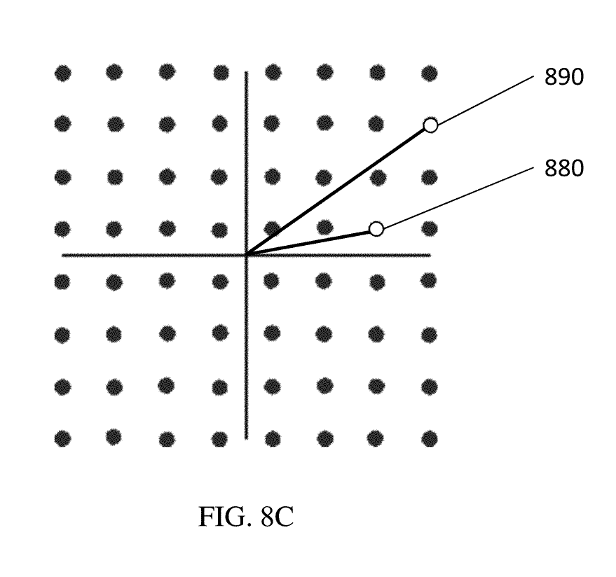

FIG. 8A shows an example of a partition containing two non-adjacent points 810 and 820. In this example, points 810 and 820 can be rotated by angles 830 and 840, respectively, to bring this group of points within the partition to a single position 850 on the real axis. In this case, angles 830 and 840 can have the same magnitude, but opposite sign. For example, angle 830 can be −45° and angle 840 can be +45°. In such an example, the magnitude of the rotation angle for both of the points in the partitioned group (e.g., 810 and 820) can be determined by taking an average angle of one of the points in the partition (e.g., 810), and applying that angle (e.g., angle 830) to that point (e.g., 810). Then the same angle with opposite sign (or opposite direction) (e.g., angle 840) can be applied to the other point (e.g., 820). This technique can be useful to reduce the number of calculations when applying the methods described herein to higher order QAM constellations, where many calculations will be needed to rotate all of the points in the constellation to the real axis. Although the same angle magnitude is being applied to multiple points, this method is different than phase noise reduction in QPSK signals using existing methods, since the needed rotations for all of the points in the constellation will not be achieved through a simple M^{th} power operations. Furthermore, the number of non-adjacent points in the partitioned group can be a number other than 4 (e.g., there can be 2, 8 or any other appropriate number of points in the partitioned group).

In another example, the magnitude of the rotation angles for all the points in the partitioned group containing non-adjacent points (e.g., 810 and 820 in FIG. 8A) can be determined by calculating the average angle for both groups of points in the partition separately, then averaging those average angles, and then applying that average angle to all points in the partitioned group, after multiplying by a constant (e.g., +1 or −1).

In some embodiments, more than 2 non-adjacent points in a partition can be processed similarly to the methods described above, to bring the points to one or more locations on the real axis by rotating the points by angles with the same magnitude and one or more signs or directions. In such embodiments, the magnitude of the rotation angles can be determined by one, or more than one, point in the partition.

Another example is shown in FIG. 8B, where a partitioned group containing non-adjacent points 811 and 821. In this example, points 811 and 821 can be rotated by angles 831 and 841, respectively, to bring this group of points within the partition to two different positions 851 and 852, respectively, on the real axis. In this case, angles 831 and 841 can have the same magnitude, and the same sign. For example, angles 831 and 841 can be −45°. In such an example, the magnitude of the rotation angle for all the points in the partitioned group (e.g., 811 and 821) can be determined by taking an average angle of one of the groups of points in the partition (e.g., 811), and applying that angle (e.g., angle 831) to both points (e.g., 811 and 821). This technique can also be useful to reduce the number of calculations when applying the methods described herein to higher order QAM constellations, where many calculations will be needed to rotate all the points in the constellation to the real axis. Although the same angle magnitude is being applied to multiple points, this method is different than phase noise reduction in QPSK signals using existing methods, since the needed rotations for all the points in the constellation will not be achieved through a simple M^{th} power operation, and the number of non-adjacent points in the partitioned group can be a number other than 4 (e.g., there can be 2, 8 or any other appropriate number of points in the partitioned group).

In some embodiments, a constellation (e.g., a 16-QAM constellation) can be partitioned into groups (e.g., 8 groups), each containing 2 points, where the 2 points in each partition are located 180° apart from one another. In this case, the average position or angle of the 2 points can be used to determine an angle of rotation, and the angle of rotation applied equally to both points within the partition to bring one point to a positive position on the real axis, and one point to a negative position on the real axis. Alternatively, the angle of rotation can be applied to one of the points without transformation, and the second point can be rotated by the angle plus 180° to bring both points to the same position on the real axis.

In some embodiments, methods similar to those described above can be used for points within a partition that have different magnitude angles, by multiplying the magnitude of a single calculated angle by a constant other than +/−1 and applying those rotation angles to the appropriate points in the partition. In some embodiments, one angle is calculated for one (or more than one) point in a partition, and the calculated angle is multiplied by a constant, and then a constant value is added or subtracted, to determine the magnitude of the rotation angles for the remaining points within the partitioned group. For example, in a 64 QAM constellation, the smallest angle point away from the real axis is approximately 8.1°. An example 64 QAM constellation is shown in FIG. 8C. In this example 64 QAM constellation, a partitioned group contains two non-adjacent points 880 and 890, shown as white points. Using methods similar to those described above, the average angle of point 880 can be determined to be approximately 11.3°. Then that average value of 11.3° can be multiplied by 2.4, and 8.1° subtracted from that product to determine the angle of rotation for the other point in the partitioned group 890, which requires a rotation angle of approximately 35.5°.

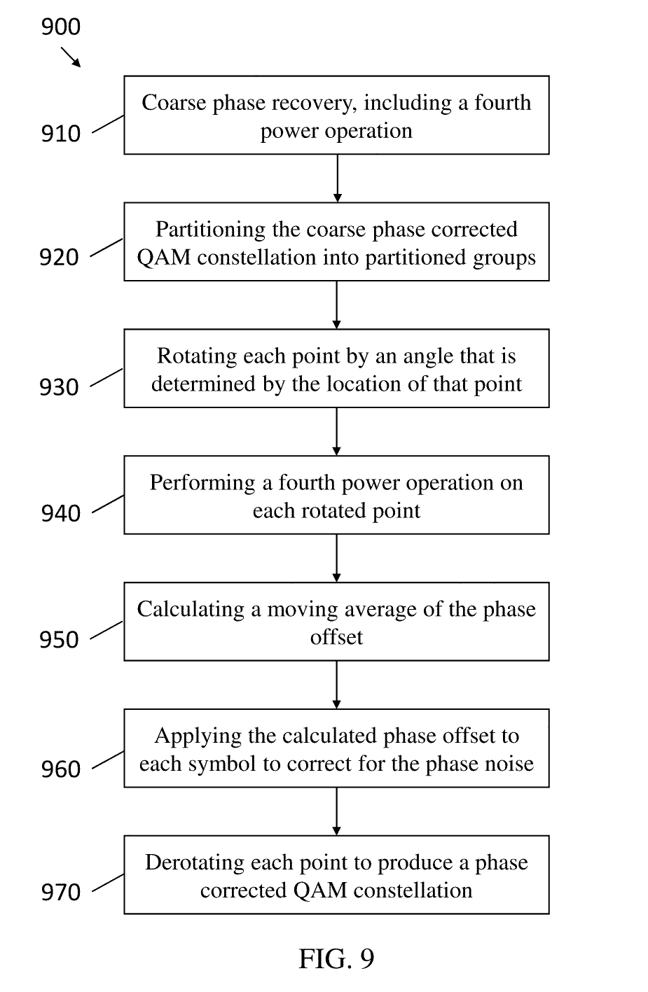

FIG. 9 shows a flowchart for a method 900 for phase recovery performed by a phase recovery system in a QAM system (e.g., a higher order QAM system), in some embodiments. The method 900 includes 910 performing a coarse phase recovery, which includes a fourth power operation. The method further includes 920 partitioning (or subdividing) the coarse phase corrected QAM constellation into partitioned groups. After partitioning, in operation 930 each point is rotated by an angle that is determined by the location of that point in the constellation. Alternatively, each point can be rotated by an angle that is determined by the partition of that point in the constellation, or by the location of that point and the location of one or more points in the partition or the constellation. Next, in operation 940 a fourth power operation is performed on each rotated point of the rotated coarse phase corrected constellation. In operation 950, a moving average of the phase offset is calculated (or estimated) for each point to determine a phase offset of that point. Alternatively, a moving average of the phase offset can be calculated for a group of points. In some embodiments, a phase evolution (e.g., a fine phase correction function or phase offset function) is determined for one or more points. In operation 960, the calculated (or estimated) phase offset is applied to each symbol or point (or group of symbols or group of points) to correct for the determined phase noise. In some embodiments, the fine phase correction function is applied to each point (or group of points) to correct for the determined phase noise. In operation 970, each point is derotated, or counterrotated, (e.g., by the opposite of the angle determined at 930) to produce a phase corrected QAM constellation.

In some embodiments, more than one coarse and/or fine phase recover process can be performed in series. For example, a coarse phase recovery can be performed (e.g., similar to step 910 in FIG. 9) and then a first fine recovery can be performed (e.g., similar to steps 920 through 970 in FIG. 9), and then a second fine recovery can be performed (e.g., by repeating steps similar to 920 through 970 in FIG. 9). In other examples, a first coarse phase recovery and a first fine phase recovery can be performed (e.g., similar to steps 910 through 970 in FIG. 9), and then a second coarse phase recovery and a second fine phase recovery can be performed (e.g., by repeating steps similar to 910 through 970 in FIG. 9). Similarly, in some examples, more than 2 coarse and/or more than 2 fine phase recovery processes can be performed in series (e.g., 1 coarse followed by 3 or more fine phase recovery processes, or alternating coarse and fine phase recovery processes 3 or more times).

In some embodiments, a system for phase recovery in a QAM system is provided. The phase recovery system includes a coarse phase recovery element (i.e., component) for performing a coarse phase recovery, which includes a coarse power transformation element capable of transforming the signal using a first M^{th} power operation, e.g., a fourth, eighth, twelfth, etc. power operation. The system further includes a partition element for partitioning the coarse phase corrected QAM constellation into partitioned groups. The system further includes a rotation element capable of rotating each point by an angle that is determined by the location of each point, or by the location of more than one point, in the constellation. Alternatively, the rotation element can rotate each point by an angle that is determined by the partition of each point in the constellation. Next, the system contains a fine transformation element capable of performing a second M^{th} power operation (e.g., a fourth, eighth, twelfth, etc. power operation) on the rotated coarse phase corrected constellation. The system also contains a phase offset element capable of calculating a moving average of the phase offset to determine a phase offset of each point. In some embodiments, the phase offset element is capable of calculating a fine phase correction function or phase offset function. Next, the system contains a phase noise correction element capable of applying the calculated (or estimated) phase offset, fine phase correction function, or phase offset function, to each symbol to correct for the determined phase noise. The system also contains a derotation element to derotate (i.e., counterrotate) each point to produce a phase corrected QAM constellation.

Reference has been made in detail to embodiments of the disclosed invention, one or more examples of which have been illustrated in the accompanying figures. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A method, comprising:
a. receiving a modulated signal having a received constellation including multiple constellation points;
b. generating coarse phase corrected points comprising performing a first coarse phase recovery on each of the multiple constellation points;
c. generating partitioned coarse phase corrected points by partitioning the coarse phase corrected points into several partitioned groups;
d. generating rotated points by rotating each partitioned coarse phase corrected point by an angle that corresponds to the location of that coarse phase corrected point in the constellation;
e. generating M^{th} power transformed points by performing an M^{th} power operation on each of the rotated points;
f. determining a fine phase correction function with the M^{th} power transformed points by performing a moving average of a phase offset of each M^{th} power transformed point, the fine phase correction function describing the phase offset of each M^{th} power transformed point as a function of time;
g. generating fine phase corrected points by performing a fine phase recovery using the fine phase correction function to apply a phase correction (calculated in step f) using the M^{th} power operation; and
h. producing a phase noise mitigated constellation by derotating the fine phase corrected points, wherein the derotating removes rotations added by the rotating and the M^{th} power operation.

2. The method of claim 1, wherein the generating coarse phase corrected points further comprises performing a coarse M^{th} power phase recovery on each of the multiple constellation points, performing a variation of a coarse M^{th} power phase recovery on each of the multiple constellation points, performing a Cartwright algorithm phase recovery on each of the multiple constellation points, or performing a variation of a Cartwright algorithm phase recovery on each of the multiple constellation points.

3. The method of claim 1, wherein the received constellation is a higher order constellation, with order 16 or greater.

4. The method of claim 1, wherein the M^{th} power operation is a fourth power operation.

5. The method of claim 1, wherein the coarse phase corrected points are partitioned into four or more partitioned groups.

6. The method of claim 1, wherein each of the partitioned coarse phase corrected points is rotated by an angle that is determined by the partitioned group of each point.

7. The method of claim 1, wherein the coarse phase corrected points are partitioned into rectangular partitioned groups.

8. The method of claim 1, wherein the partitioned groups each comprise 1 coarse phase corrected point.

9. The method of claim 1, wherein the partitioned groups each comprise 2 coarse phase corrected points.

10. The method of claim 1, wherein each of the partitioned coarse phase corrected points is rotated by an angle that is determined by the location of the point, and by a number of other coarse phase corrected points.

11. The method of claim 1, wherein each of the partitioned coarse phase corrected points is rotated by an angle that is determined by the average position of a set of 2 partitioned coarse phase corrected points.

12. The method of claim 1, wherein the received modulated signal is a quadrature amplitude modulated (QAM) signal, and the received constellation is a QAM constellation.

13. The method of claim 1, wherein the received constellation is selected from the group consisting of a ring, star, rectangle, probabilistically shaped, non-probabilistically shaped, and circular constellation.

14. The method of claim 1, wherein:
the modulated signal is modulated using trellis coding; and
the modulated signal further comprises more than one constellation.

15. The method of claim 1, wherein the received constellation changes among several different constellations over adjacent time instants.

16. The method of claim 1, further comprising:
i. after step h., generating partitioned fine phase corrected points by partitioning the fine phase corrected points into several partitioned groups;
j. generating a second set of rotated points by rotating each partitioned fine phase corrected point by an angle that corresponds to the location of that fine phase corrected point in the constellation;
k. generating a second set of M^{th} power transformed points by performing a second M^{th} power operation on each of the second set of rotated points;
l. determining a second fine phase correction function with the second set of M^{th} power transformed points by performing a moving average of a phase offset of each point in the second set of M^{th} power transformed points, the second fine phase correction function describing the phase offset of each point in the second set of M^{th} power transformed point as a function of time;
m. generating second set of fine phase corrected points by performing a second fine phase recovery using the second fine phase correction function to apply a second phase correction (calculated in step k.) using the M^{th} power operation; and
n. producing a second phase noise mitigated constellation by derotating the second set of fine phase corrected points, wherein the derotating removes rotations added by the rotating and the M^{th} power operation.

17. A method, comprising:
a. receiving a modulated signal having a received constellation including multiple constellation points;
b. generating coarse phase corrected points comprising performing a first M^{th} power phase recovery by performing a first M^{th} power operation on each of the multiple constellation points;
c. generating partitioned coarse phase corrected points by partitioning the coarse phase corrected points into several partitioned groups;
d. generating rotated points by rotating each partitioned coarse phase corrected point by an angle that corresponds to the location of that coarse phase corrected point in the constellation;
e. generating M^{th} power transformed points by performing a second M^{th} power operation on each of the rotated points;
f. determining a fine phase correction function with the M^{th} power transformed points by performing a moving average of a phase offset of each M^{th} power transformed point, the fine phase correction function describing the phase offset of each M^{th} power transformed point as a function of time;
g. generating fine phase corrected points by performing a fine phase recovery using the fine phase correction function to apply a phase correction (calculated in step f) using the second M^{th} power operation; and
h. producing a phase noise mitigated constellation by derotating the fine phase corrected points, wherein the derotating removes rotations added by the rotating and the second M^{th} power operation.

18. The method of claim 17, wherein the received modulated signal is a quadrature amplitude modulated (QAM) signal, and the received constellation is a QAM constellation.

19. The method of claim 17, wherein the received constellation is selected from the group consisting of a ring, star, rectangle, probabilistically shaped, non-probabilistically shaped, and circular constellation.

20. The method of claim 17, wherein the received constellation changes among several different constellations over adjacent time instants.
